(19) United States
(12) Patent Application Publication
(10) Pub. No.: US 2004/0106720 A1
(43) Pub. Date: Jun. 3, 2004

(54) Nanocomposite polyster preparation method

(76) Inventors: Robert Jerome, Sart Jalhay (BE); Cedric Calberg, Esneux (BE); Fabrice Stassin, Anthisnes (BE); Olivier Helleux, Fleron (BE); Philippe Dubois, Braives (BE); Nadege Pantoustier, Paris (FR); Michael Alexandre, Ougree (BE); Benedicte Lepoittevin, Paris (FR)

Correspondence Address: JACOBSON HOLMAN PLLC, 400 SEVENTH STREET N.W., SUITE 600, WASHINGTON, DC, 20004, US

(21) Appl. No.: 10/472,764

(22) PCT Filed: Mar. 28, 2002
(86) PCT No.: PCT/EP02/03597

(30) Foreign Application Priority Data
Apr. 6, 2001 (EP) 01201265.4

(51) Int. Cl. C08K 3/34

(52) U.S. Cl. 524/445

(57) ABSTRACT

The invention relates to a method for preparing nanocomposite aliphatic polyester consisting of the mixing of a nanofiller in at least one monomer that can form an aliphatic polyester and the intercalative polymerisation of the mixture obtained in the presence of a supercritical fluid.

The invention relates to a method for preparing an aliphatic polyester nanocomposite.

Aliphatic polyesters are known and used for their properties of biodegradability and biocompatibility. However, their thermo-mechanical properties are not adequate for them to be used in certain applications. They suffer from limited thermal properties, low rigidity, inadequate barrier properties and poor fire behaviour.

A dispersion of nanofillers in a polymer is known to improve those thermo-mechanical properties but until now, for aliphatic polyesters, none of the improvements has proved satisfactory.

Polyester nanocomposites are known in the art.

N. Ogata et al, in J. Polym. Sci. Part B: Polym. Phys. 35 (1997), describe a method for preparing, in chloroform, poly (L-lactide) filled with montmorillonite that has been surface organomodified with diastearyldimethylammonium ions. However, the organomodified montmorillonite is not properly dispersed in the poly(L-lactide). Indeed, the filler does not have a non-aggregated structure in the final composite, i.e. with non-delaminated/exfoliated silicate lamellae. That structure alone guarantees good barrier properties.

G. Jimenez, N. Ogata et al in J. Appl. Polym. Sci. 64 (1997) 2211-2220 describe the preparation, in an organic solvent (also chloroform) of poly (ε-caprolactone) filled with montmorillonite organomodified with diastearyldimethylammonium ions. Again, dispersion of the filler in the final composite is poor. Further, that method for preparing nanocomposite polymers is carried out in organic solvents the use of which is becoming ever more restricted under environmental protection regulations.

In 1995, Messersmith, in J. Polym. Sci. Part A: Polym. Chem. 33, 1047-1057 described a method for preparing poly (ε-caprolactone) filled with montmorillonite organomodified with 12-aminododecanoic acids starting from polymerization in the absence of a solvent. The preparation method necessitates a prior step for ions transfer between the montmorillonite and the amino acid before in-situ polymerization of the polyester. The polymerization is initiated without a catalyst after raising the temperature to 170° C. This preparation method suffers from a number of problems. The polymerization is lengthy, of the order of 48 hours as the filler has to be allowed to swell in the ε-caprolactone. Further, the molecular masses of the poly(ε-caprolactone)s obtained are low (Mn less than 10000). Further, while replacing the solvent with a monomer improves the environmental aspect of the method, the final composite comprises molecules of monomer that have not reacted and therefore is impure. Said molecules can only be eliminated by a specific subsequent treatment.

It should also be noted that compared with pure poly(ε-caprolactone), the permeability to water of the poly(ε-caprolactone) nanocomposite obtained is substantially reduced, with a dispersion of only 4.8% by weight of nanofillers.

It is also known from the prior art that supercritical CO₂ extraction processes can be used to obtain products with greater purity. Said processes have been used, for example, in U.S. Pat. No. 5,073,267, to extract volatile compounds or to purify polymers of their residual monomers, as in U.S. Pat. No. 4,902,780. However, those extraction processes are carried out after the polymerization step and thus necessitate a supplemental step for filtering the final product.

High purity polyesters are desirable in medical and biomedical applications, for example. Reaction residues such as monomers, catalysts, initiators are considered to be highly toxic for such applications and must therefore be eliminated.

The present invention aims to improve the method for preparing aliphatic polyester nanocomposites to obtain a high purity nanocomposite endowed with improved thermo-mechanical properties while retaining its remarkable properties of biodegradability and biocompatibility.

The invention concerns a method for preparing an aliphatic polyester nanocomposite comprising mixing a nanofiller into at least one monomer that is capable of forming an aliphatic polyester and carrying out intercalative polymerization of the mixture obtained in the presence of supercritical fluid.

Within a relatively short period of time, this method can produce polyesters nanocomposites with higher purity than those obtained in volatile organic solvents and with physico-chemical properties that are better than those obtained by other methods. A further advantage of the invention is its capacity to produce composite polyesters with nanofillers contents of substantially greater than 10%. The use of a supercritical fluid as a solvent for the reaction medium is also a solution of choice to the problem of the environmental pollution caused by organic solvents.

Intercalative polymerization of polymeric nanocomposites is a synthesis confined to the interior of spaces of molecular dimensions. The polymerization can be initiated either thermally or catalytically after adsorption of a monomer inside a host compound to produce a composite with a structure that is exfoliated to a greater or lesser extent and will thus determine the physico-chemical properties of the nanocomposite.

The method for preparing the aliphatic polyesters nanocomposites of the invention is carried out in a high pressure reactor that has been conditioned under vacuum or in an inert gas, necessitated by ring opening polymerization of aliphatic esters. Desired quantities of nanofillers and monomer are then introduced into the reactor in a stream of an inert gas, for example nitrogen or CO₂, at a temperature which is generally ambient temperature. In the case of catalytic polymerization, an initiator solution is transferred in the same manner. The monomer, nanofiller and initiator can be introduced in any order.

If the initiator is in solution in a solvent, the solvant can be evaporated off.

The reactor is then filled with supercritical fluid and heated to the polymerization temperature. The pressure and agitation are adjusted to between 50 and 500 bars and 0 to 2000 rpm respectively. When polymerization has terminated, the reactor is conventionally cooled to ambient temperature and the pressure is slowly released. The aliphatic polyester nanocomposite obtained is recovered from the reactor, generally in the form of a powder.

The monomers used in the present invention are lactides, lactones (for example ε-caprolactone), dilactones, glycolide or mixtures thereof.

In particular, the method for preparing the aliphatic polyester nanocomposite is characterized in that the monomer is a lactone, more particularly ε-caprolactone.

In a preferred variation, the monomer is a lactide.

Examples of the supercritical fluids used in the present invention are CO₂, NO₂, low molar weight alkanes such as n-butane, propane or ethane, or mixtures thereof.

Preferably, CO₂ is used. The toxicity of that gas is very low. It is naturally abundant and large local resources exist resulting from human activities (discharges from thermal power stations, for example). Supercritical CO₂ is cheap, easy to handle and has a zero explosive or combustive power.

In the preparation method of the invention, the supercritical fluid can be used alone or in the presence of a co-solvent, for example an organic solvent with a certain polarity. The co-solvent is preferably in a minor concentration in the reaction medium.

When the supercritical fluid is CO₂, a percentage of less than 5% by volume of a volatile organic solvent with a higher polarity can be added to enhance its solvating power. An example is acetone.

The nanofillers used in the present invention are silicates, generally clays, in particular phyllosilicates such as montmorillonite, nontronite, beidelite, volkonskoite, hectorite, saponite, sauconite, magadiite, medmontite, fluorohectorite, vermiculite, kaolinite.

Clays, in particular phyllosilicates, which have a lamellar structure, contain for example alkali cations such as K⁺ or Na⁺ or alkaline-earth cations or even organic cations such as alkylammonium or alkylsulphonium ions, obtained by ion exchange reactions, between their lamellae.

Preferred used nanofillers in the present invention are organomodified with quaternary ammonium N⁺R₁R₂R₃R₄ type ions in which R¹, R², R³ and R⁴, which may be identical or different, represent hydrogen, an alkyl group having 1 to 25 carbon atoms, a phenyl group or an alkyl group comprising one or more functions selected from the group constituted by amine, epoxide, acid, hydroxyl, thiol, ester, nitro, nitrile or ketone.

An example is an organomodified nanofiller with dimethyldioctadecyl ammonium ions, quaternized octadecylamine ions, dimethyl(2-ethylhexyl) hydrogenated tallow ammonium ions or aminodecanoic acids.

If chemical grafting between the polymer chains and the lamellae of the nanofiller is to be encouraged, then a nanofiller organomodified with quaternary ammonium ions one or more alkyl groups of which carries one or more hydroxyl or thiol functions is advantageously used. In particular, a nanofilled organomodified with methyl hydrogenated tallow bis-2-hydroxyethyl ammonium ions is used.

In a variation of the preparation method of the invention, a particulate microfiller is also added to the monomer-nanofiller mixture.

The microfillers used in the present invention are additives or thermo-mechanical strengtheners which can enhance the physico-chemical properties of the nanocomposite polymers. Examples are non modified type montmorillonite clays, aluminium hydroxide (ATH), magnesium hydroxide (MTH), zinc borate (ZB), starch, or a mixture of said additives.

In a further variation of the preparation method of the invention, a surfactant is added to encourage polymer chain growth, the production of particular morphologies (particles or foams, for example) or the elimination of the catalyst by supercritical extraction. Said surfactants are generally in the form of two sequences, one being soluble in the supercritical fluid and the other interacting with the growing polyester chains. If the supercritical fluid is CO₂, then a fluorinated, silicone-containing or carbonate-containing surfactant is preferred. The choice of the second sequence will clearly depend on the nature of the synthesized polymer. It can, for example, have the same nature as the former. More detailed information concerning the design of surfactants to be used can be found in the articles by Steven M. Howdle (for example: Macromolecules 2000, 33, 237-239 and Macromolecules 2000, 33, 1996-1999), by Joseph DeSimone (Macromolecules 1997, 30, 5673-5682 and Science, vol 274, 2049-2052) and by Eric J. Beckman (Macromolecules 1997, 30, 745-756).

In the method for preparing the aliphatic polyester nanocomposite of the invention, polymerization initiation can be thermal or catalytic.

If polymerization initiation is catalytic, polymerization of the cyclic esters encompassed by the invention can be induced using any catalyst that is known to the skilled person. In particular, it is possible to select a metal alcoholate, the metal atom of which contains p, d or f orbitals of favourable energy, such as in Mg, Ti, Zr, Fe, Zn, Al, Sn, Y, La or Hf, which are particularly attractive. Preferably, dimethoxydibutyl tin (Bu₂Sn(OCH₃)₂) or aluminium isopropylate (Al(OiPr)₃) is used in the present invention.

In a further variation, a metal oxide, a metal chloride or a metal carboxylate can be used, the metal atom of which contains p, d or f orbitals of favourable energy, such as in Mg, Ti, Zr, Fe, Zn, Al, Sn, Y, La or Hf, in the presence of a protic species, such as an alcohol, a thiol, an amine or water, which are particularly attractive. Preferably, tin octoate (Sn[OC(O)—CH(CH₂—CH₃)—(CH₂)₃—CH₃]₂ is used in the present invention.

The skilled person is free to select and optimize the precise experimental conditions for polymerizing the monomers encompassed by the invention. They are a function of the monomer(s) selected, the catalyst and its concentration, the reaction temperature, and the desired degree of conversion. Examples of the operating conditions are given by way of indication in the examples.

When the nanofiller, the monomer and the polymerization conditions are carefully selected by the skilled person, the nanocomposites obtained according to the invention have thermo-mechanical properties that are substantially better than those for nanocomposites prepared conventionally in the absence of a solvent or in organic solvents, and more particularly as regards the barrier effect, tensile strength, thermal resistance or fire resistance. The nanocomposites of the invention exhibit complete exfoliation of the nanofiller, as shown by X ray diffraction analysis. The thermal stability of the nanocomposites generated, as shown by differential thermogravimetric analysis, is considerably improved compared with that of unfilled polymers, even with a very small nanofiller content (less than 5% by weight in the final composite).

Adding particulate microfillers to the mixture of nanocomposite polymers further improves these thermo-mechanical properties.

In a further variation of the invention, nanocomposite polymers containing substantially more than 10% of filler (for example more than 50%) obtained from the preparation method of the invention can be used as master batches. They are then mixed in a molten medium in a roll mill, a mixing chamber or a polymer extruder, which may or may not be filled with microfillers, to obtain nanocomposites with a low filler content, preferably of the order of 5% by weight.

The choice of polymer, which may or may not be filled with microfillers, will depend on the nature of the polyester constituting the nanocomposite with a high nanofiller content. To guarantee good thermo-mechanical properties of the final nanocomposite, then two thermodynamically miscible polymers will advantageously be selected. In the particular case of a nanocomposite based on poly(ε-caprolactone), it will be mixed with poly(ε-caprolactone), polyvinyl chloride (PVC), acrylonitrile-butadiene-styrene (ABS), styrene-acrylonitrile copolymers (SAN) or other cellulosic derivatives.

Said master batches with a high nanofiller content can, for example, be obtained by stopping polymerization by depressurizing the reactor at a low monomer conversion. In this example, the molecules of unreacted monomer are eliminated by supercritical extraction.

The nanocomposite polymers obtained by the mixing method have exceptional thermo-mechanical properties as regards the barrier effect, tensile strength, thermal resistance and fire resistance. The addition of particulate microfillers to the mixture of nanocomposite polymers further enhances the above thermo-mechanical properties.

Said nanocomposite polymers obtained by the preparation method of the invention can be used in a variety of applications requiring thermal resistance and even fire resistance. Their purity also means that they can be used in medical and biomedical applications.

The following examples illustrate the invention.

### EXAMPLE 1

### Poly(ε-caprolactone)-montmorillonite Organomodified with Methyl Hydrogenated Tallow bis-2-hydroxyethyl Ammonium Ions

The reaction was carried out in a stainless steel high pressure reactor with a capacity of 120 ml provided with a heated jacket and a magnetic agitation system. The pressure, temperature and agitation speed were constantly controlled.

Prior to polymerization, the reactor was carefully conditioned. To this end, the reactor was heated to a temperature of 65° C. to desorb molecules that could interfere with the polymerization reaction from the reactor walls. It was than purged in a stream of nitrogen for 15 min and cooled to ambient temperature by reducing the pressure (typically 0.1 mm Hg) for one hour. It was then purged with nitrogen (N28 grade, standard quality, Air Liquide) for 15 min.

Initially, the desired quantity of nanofillers was introduced into the reactor at normal temperature under nitrogen. The initiator solution was transferred in the same manner using a syringe. The toluene (the solvent for this solution) was then evaporated off by reducing the pressure in the reactor. Once this step had been carried out, the monomer was supplemented with the filler-initiator mixture in a stream of nitrogen. The nitrogen was eliminated from the reactor by flushing with CO₂. The reactor was filled with liquid CO₂ to reach a pressure of approximately 140 bars then slowly heated to the reaction temperature. The pressure and agitation were then adjusted to 160 bars and 1700 rpm. After 24 hours, the reactor was cooled to 25° C. and the pressure was slowly released. The polyester nanocomposite was recovered from the reactor in the form of a powder and had the following characteristics:

| | | amount of | Mn, | | Mn, |
|---|---|---|---|---|---|
| sample | clay used | filler | theory | conversion | measured |
| 30 | Cloisite 30B | 5% | 10000 | 85% | 11000 |
| 31 | Cloisite 30B | 1% | 15000 | 87% | 20200 |

Experimental conditions for polyester nanocomposites 30 and 31 above:

Polymerization was carried out at 160 bars for 24 h. The reaction temperature was 50° C. The following reagent quantities were used:

Sample 30:

1 g of clay organomodified with methyl hydrogenated tallow bis-2-hydroxyethyl ammonium ions sold by Southern Clay Products under the trade name Cloisite 30B;

20 g of ε-caprolactone (99%, Aldrich);

2 ml of a 1.026 M solution of tin alcoholate (Bu₂Sn(OCH₃)₂) in toluene. This product is sold by Aldrich.

Sample 31:

0.2 g of Cloisite 30B;

20 g of ε-caprolactone, Aldrich (purity 99%);

1.3 ml of a 1.026 M solution of tin alcoholate (Bu₂Sn(OCH₃)₂) in toluene. This product is sold by Aldrich.

The molecular mass was measured as follows: the samples were dissolved in toluene. In order to break the bonds between the clay and poly (ε-caprolactone), a solution of lithium chloride (1% by weight in a THF/toluene, 50:50 v/v mixture) is added to destroy the gel structure formed. After agitating for 24 hours, the gel has disappeared and the solution could be filtered to separate the precipitate (clay) from the filtrate (containing the poly(ε-caprolactone). The filtrate was then precipitated from heptane to recover the “free” poly(ε-caprolactone) (PCL) formed. The molecular masses were then estimated by steric exclusion chromatography (GPC) in THF at 35° C. using polystyrene standards [M_{PCL}=0.259×(M_{PS})^{1.073}].

X ray diffraction analysis (XRD) allowed the specific interplanar spacings (d) of the clays alone and in the “polymer+clay” composites to be determined to allow comparison and to provide evidence for any intercalation of the polymer into the silicate layers of the clay.

The X ray diffraction data for mixtures 30 and 31 provide evidence for exfoliation of the nanofiller. The characteristic signal for the interplanar spacing for the lamellae of the filler had completely disappeared. Dispersion of the filler in the composite could thus be considered to be excellent.

The fire behaviour of the two samples was also excellent. They burned slowly and were consumed by producing ash (without the production of a flaming drop).

### EXAMPLE 2

### Poly(ε-caprolactone)-montmorillonite Organomodified with Dimethyldioctadecyl Ammonium Ions

The reaction was carried out as described in Example 1, but at a pressure of 190 bars instead of 160 bars.

The polyester nanocomposites obtained had the following characteristics:

| | | amount of | Mn, | | |
|---|---|---|---|---|---|
| sample | clay used | filler | theory | conversion | Mn |
| 32 | Cloisite 25A | 5% | 15000 | 70% | 13100 |
| 33 | Cloisite 25A | 1% | 10000 | 87% | 12800 |

Experimental conditions for polyester nanocomposites 32 and 33 above:

Polymerization was carried out at 190 bars for 24 h. The reaction temperature was 50° C.

The following reagent quantities were used:

Sample 32:

1 g of clay organomodified with dimethyldioctadecyl ammonium ions sold by Southern Clay Products under the trade name Cloisite 25A;

20 g of ε-caprolactone (99%, Aldrich);

1.3 ml of a 1.026 M solution of tin alcoholate (Bu₂Sn(OCH₃)₂) in toluene (Aldrich).

Sample 33:

0.2 g of Cloisite 25A;

20 g of α-caprolactone;

2 ml of a 1.026 M solution of tin alcoholate (Bu₂Sn(OCH₃)₂) in toluene (Aldrich).

The X ray diffraction data for mixtures 32 and 33 provided evidence for exfoliation and intercalation of the nanofiller. The characteristic signal for the interplanar spacing for the lamellae of the filler was very weak, broad and with a maximum centered on a high interplanar spacing (29.7 nm). Scanning microscopic analysis confirmed the nanofiller exfoliation, and clearly distinct lamellae were observed. The dispersion of the filler in the composite could thus be considered to be very good.

The fire behaviour of the two samples was also excellent. They burned slowly and were consumed by producing ash (without the production of a flaming drop).

### EXAMPLE 3

### Poly(1-lactide)-montmorillonite Organomodified with Methyl Hydrogenated Tallow bis-2-hydroxyethyl Ammonium Ions

The reaction was carried out as described in Example 1, except that L-lactide was used as the monomer. To accelerate dissolution in the reaction mixture, the reaction temperature was raised to 65° C. Polymerization was carried out at a pressure of 195 bars

The polyester nanocomposite obtained had the following characteristics:

| | | amount of | | |
|---|---|---|---|---|
| sample | clay used | filler | Mn, theory | conversion |
| 38 | Cloisite 30B | 5% | 10000 | 93% |

Experimental conditions for polyester nanocomposite 38 above:

Polymerization was carried out at 195 bars for 27 h. The reaction temperature was 65° C.

The following reagent quantities were used:

1 g of Cloisite 30B;

20 g of L-lactide sold by Boehringer 1 ng;

2 ml of a 1.026 M solution of tin alcoholate (Bu₂Sn(OCH₃)₂) in toluene (Aldrich).

The fire behaviour of this sample provided evidence for the formation of a nanocomposite and of the good dispersion of the nanofiller in it.

### EXAMPLE 4

### Poly(ε-caprolactone-co-L-lactide)-Montmorillonite Organomodified with Methyl Hydrogenated Tallow bis-2-Hydroxyethyl Ammonium Ions

The reaction was carried out as described in Example 1, except that the ε-caprolactone monomer was replaced by a mixture of α-caprolactone and L-lactide monomers.

The L-lactide and ε-caprolactone were copolymerized to modify the mechanical properties of the resulting polymer.

The polyester nanocomposite obtained had the following characteristics:

| | | amount of | | |
|---|---|---|---|---|
| sample | clay used | filler | Mn, theory | conversion |
| 39 | Cloisite 30B | 5% | 10000 | 60% |

Experimental conditions for polyester nanocomposite 39 above:

Polymerization was carried out at 190 bars for 24 h. The reaction temperature was 70° C.

The following reagent quantities were used:

1 g of Cloisite 30B;

10 g of L-lactide, 10 ml of ε-caprolactone. The two monomers were added simultaneously;

2 ml of a 1.026 M solution of tin alcoholate (Bu₂Sn(OCH₃)₂) in toluene.

The mechanical behaviour of this sample provided evidence for the formation of an amorphous random copolymer. The two monomers copolymerized well under these conditions to form a nanocomposite, as shown by the TGA measurements and the behaviour of the sample once exposed to a flame. The fire behaviour of the sample provided evidence for good dispersion of the nanofiller in the composite.

### EXAMPLE 5

### Poly(ε-caprolactone)-non-modified Montmorillonite

The reaction was carried out as described in Example 1, with the exception that the nanofiller was replaced by a non-modified clay, Cloisite Na⁺. The pressure is 210 bars and the reaction temperature is 50° C.

The polyester nanocomposite obtained had the following characteristics:

| | | | | con- | | poly- |
|---|---|---|---|---|---|---|
| | clay | amount of | Mn, | ver- | Mn, | dispersi- |
| sample | used | filler | theory | sion | measured | bility |
| 41 | Cloisite | 1% | 10000 | 94% | 10700 | 1.6 |
| | Na⁺ | | | | | |

Experimental conditions for polyester nanocomposite 41:

Polymerization was carried out at 210 bars for 24 h. The reaction temperature was 50° C.

The following reagent quantities were used:

0.2 g of Cloisite Na⁺ sold by Southern Clay Products;

20 ml of α-caprolactone (99%, Aldrich);

2 ml of a 1.026 M solution of tin alcoholate (Bu₂Sn(OCH₃)₂) in toluene (Aldrich).

X ray diffraction analysis of this sample showed that the characteristic peak for the interplanar spacing between the lamellae of the filler had disappeared. The dispersion of the nanofiller in the nanocomposite could thus be considered excellent.

### EXAMPLE 6

### Poly(ε-caprolactone)-montmorillonite Organomodified with Dimethyldioctadecyl Ammonium Ions

The reaction was carried out as described in Example 2, but the reaction was initiated thermally.

The polyester nanocomposite obtained had the following characteristics:

| | | amount of | | |
|---|---|---|---|---|
| sample | clay used | filler | conversion | Mn, measured |
| 42 | Cloisite 25A | 5% | 92% | 16100 |

Experimental conditions for polyester nanocomposite 42:

Polymerization was carried out at 190 bars for 24 h. For the first hour of reaction, the reaction temperature was 170° C., then it was reduced to 50° C.

The following reagent quantities were used:

1 g of clay organomodified with dimethyldioctadecyl ammonium ions sold by Southern Clay Products under the trade name Cloisite 25A;

20 g of ε-caprolactone (99%, Aldrich);

### EXAMPLE 7

### Poly(ε-caprolactone)-organomodified Montmorillonite, and Mechanical Properties

The reaction was carried out as described in Example 1 and in Example 2, but at a pressure of 170 bars. The polyester nanocomposites obtained had the following characteristics:

| | | amount of | Mn, | | |
|---|---|---|---|---|---|
| sample | clay used | filler (%) | experimental | Mw/Mn | conversion |
| E43 | Cloisite 30B | 3 | 29000 | 1.8 | 100 |
| E44 | Cloisite 25A | 3 | 41000 | 1.6 | 100 |

Experimental conditions for polyester nanocomposites 43 and 44 above:

Nanocomposite E43 was obtained by polymerizing ε-caprolactone (30 g) catalyzed by dimethoxy dibutyl tin (0.12 g) in the presence of montmorillonite organomodified with methyl hydrogenated tallow bis-2-hydroxyethyl ammonium ions (0.9 g, i.e. 3% by weight with respect to the monomer). The reaction mixture was brought to a pressure of 170 bars and a temperature of 50° C. for 24 hours.

Nanocomposite E44 was produced in identical manner, this time in the presence of montmorillonite organomodified with dimethyldioctadecyl ammonium ions.

These polyester nanocomposites underwent conventional tensile tests under the following conditions: draw rate 30 mm/min; grip separation: 30 mm; cross-section: 10 mm².

TABLE 1
Mechanical properties of nanocomposites of the invention

| sample | stress at break (MPa) | extension (%) | modulus (MPa) |
|---|---|---|---|
| E43 | 26.4 ± 1.4 | 729 ± 120 | 170 ± 16 |
| E44 | 18.4 ± 1.6 | 410 ± 42 | 135 ± 12 |

This table demonstrates the good mechanical properties of these two samples, in particular the sample based on Cloisite 30B which, even though the molecular mass is lower, has far better mechanical properties at break.

The fire behaviour of said samples was also excellent.

### EXAMPLE 8

### Mixture of Filled and Unfilled poly(ε-caprolactone): Master Batch Method

The nanocomposite obtained using the preparation method of the invention and with a large amount of nanofillers was then mixed with unfilled poly(ε-caprolactone) to obtain a nanocomposite with a low filler content.

The polymerization conditions were similar to those described above.

The table below shows the nature and composition of three “master mixtures” starting from Cloisite 25A, Cloisite 30B and Cloisite Na⁺ respectively.

TABLE 1
Results of polymerization of ε-caprolactone in
the presence of nanofillers (Mw/Mn = polymolecularity
index, also known as the polydispersity)

| master batch | Mn | | |
|---|---|---|---|
| PCL/nanofiller | (g/mol) | Mw/Mn | % filler |
| PCL/ Cloisite 30B | 7600 | 1.32 | 18.6 |
| PCL/ Cloisite 25A | 9800 | 1.90 | 25.0 |
| PCL/ Cloisite Na⁺ | 8600 | 1.08 | 43.0 |

The subsequent mixing of these nanocomposite polymers (master batches) with poly(ε-caprolactone was produced in a roll mill at 130° C. for 15 minutes and their mechanical properties (tensile test) are compared with those of the reference PCL (produced by Solvay) in Table 2.

TABLE 2
Mechanical properties of different mixtures based
on PCL (analysis conditions: ASTM D638 TYP 5 draw
rate: 50 mm/min; grip separation: 25.4 mm)

| | | stress | elongation | Young's |
|---|---|---|---|---|
| | clay | at break | at break | modulus |
| | % | (MPa)¹⁾ | (%)¹⁾ | (MPa)¹⁾ |
| reference PCL | 0 | 48.1 ± 0.2 | 1374 ± 10.7 | 222.5 ± 5.7 |
| PCL + master | 3 | 23.7 ± 2.1 | 473.7 ± 66 | 261.3 ± 6.2 |
| batch | | | | |
| PCL/cloisite Na⁺ | | | | |
| PCL + master | 3 | 20.9 ± 1 | 404.4 ± 39 | 264.0 ± 5.4 |
| batch | | | | |
| PCL/cloisite 25A | | | | |

¹⁾Each value is the mean of 4 to 6 tensile test samples.

Thermogravimetric analysis provided an estimate of the thermal stability of the different mixtures obtained. It was carried out from 25° C. to 625° C. under air at a heating rate of 20° C./min.

The following table shows the results of the thermogravimetric analysis of the two mixtures.

TABLE 3
Results of thermogravimetric analysis of different mixtures

| | temperature after |
|---|---|
| | 50% weight loss |
| reference PCL | 387 |
| PCL + master batch | 411 |
| PCL/Cloisite 30B | |
| PCL + master batch | 402 |
| PCL/Cloisite 25A | |

This analysis clearly shows the effect of incorporating the master batch into the PCL, i.e. an increase in the thermal stability of the order of 15° C. to 25° C.

### EXAMPLE 9

### Mixture of poly(ε-caprolactone) Filled with PVC

Polyester nanocomposites obtained using the preparation method of the invention and with a high nanofiller content were mixed with plasticized stabilized PVC sold by SOLVAY, in a manner similar to that described in Example 8.

The mixture was then press moulded at 150° C. to prepare samples for mechanical analyses (tensile test).

The fire behaviour of these samples provides evidence for the formation of nanocomposites.

### EXAMPLE 10

### Mechanical Properties

Table 4 shows the results of tensile tests carried out on several mixtures obtained in accordance with the invention.

TABLE 4
Mechanical properties of different mixtures obtained in accordance
with the invention (analytical conditions: tensile tests, draw rate:
50 mm/min, ASTM D638 TYP 5; grip separation: 25.4 mm).

| | | stress | elongation | Young's |
|---|---|---|---|---|
| | | at break | at break | modulus |
| | mixture | (MPa)^{b} | (%)^{b} | (MPa)^{b} |
| 1 | PCL alone | 49.9 ± 0.2 | 1376.3 ± 10.7 | 210.3 ± 5.7 |
| 2 | PCL + Mont-Na⁺ | 37.2 ± 2.5 | 705.7 ± 46.4 | 243.7 ± 5.0 |
| 3 | PCL + starch | 15.7 ± 0.5 | 550.0 ± 20.0 | 306.0 ± 10.0 |
| 4 | PCL + ATH | 18.7 ± 0.5 | 468.4 ± 20.8 | 232.1 ± 7.5 |
| 5 | PCL + ZB | 22.1 ± 0.9 | 531.2 ± 30.1 | 296.3 ± 11.0 |
| 6 | PCL + Mont- | 31.1 ± 2.8 | 619.9 ± 64.0 | 279.0 ± 16.3 |
| | C18NH3⁺ | | | |
| 7 | PCL + Mont- | 13.4 ± 0.3 | 314.9 ± 10.5 | 247.8 ± 17.1 |
| | C18NH3⁺+ | | | |
| | starch | | | |
| 8 | PCL + Mont- | 15.0 ± 0.4 | 341.9 ± 15.9 | 245.2 ± 13.2 |
| | C18NH3⁺+ | | | |
| | ATH | | | |
| 9 | PCL + Mont- | 15.7 ± 1.0 | 332.7 ± 22.5 | 276.3 ± 51.0 |
| | C18NH3⁺+ ZB | | | |
| 10 | PCL + Mont- | 25.5 ± 2.9 | 507.2 ± 94.0 | 225.3 ± 11.7 |
| | 2CNC8C18 | | | |
| 11 | PCL + Mont- | 13.2 ± 0.2 | 344.8 ± 9.1 | 246.2 ± 12.8 |
| | 2CNC8C18 + | | | |
| | starch | | | |
| 12 | PCL + Mont- | 14.7 ± 0.1 | 350.5 ± 4.1 | 248.6 ± 17.5 |
| | 2CNC8C18 + | | | |
| | ATH | | | |
| 13 | PCL + Mont- | 17.8 ± 0.5 | 420.1 ± 29.0 | 328.9 ± 24.9 |
| | 2CNC8C18 + ZB | | | |

The reference polycaprolactone (PCL) had a molecular mass Mₙ of 47500 (M_{w}/Mₙ=1.42). The nanofillers used were montmorillonites organomodified with quaternized octadecylamine ions (Mont-C18NH3⁺) or by dimethyl(2-ethylhexyl) hydrogenated tallow ammonium ions (Mont-2CNC8C18).

Considering the mechanical properties of the binary mixtures obtained (PCL+nanofiller mixtures), Table 4 clearly shows an increase in the Young's modulus (meaning an increase in the rigidity of the system) compared with the reference PCL matrix.

The addition of a particulate microfiller to the nanocomposites entrains, as expected, a certain loss in stress at break and elongation at break properties, but an increase in the Young's modulus. This increase was greater when the microfiller employed was zinc borate.

### EXAMPLE 11

### Thermal Properties

Thermogravimetric analysis (TGA) allows the thermal stability of the different mixtures obtained to be estimated. It was carried out at 25° C. up to 600° C. under air at a heating rate of 20° C./min.

Table 5 shows the results of thermogravimetric analysis of several mixtures. In general, we observe that they are more thermally stable than poly(ε-caprolactone) alone.

The mixtures were composed of poly(ε-caprolactone) and montmorillonite either non-modified (Mont-Na⁺) or organomodified with dimethyl(2-ethylhexyl) hydrogenated tallow ammonium ions (Mont-2CNC8C18) or by quaternized octadecylamine ions (Mont-C18NH3⁺).

TABLE 5
Results of thermogravimetric analysis of mixtures (analysis conditions:
25° C. to 600° C., heating rate: 20° C./min, under air)

| | | onset of | [DTGA]** | residue at |
|---|---|---|---|---|
| | | degradation | degradation | 575° C. |
| | mixture | (° C.) | peaks (° C.) | (%) |
| 1 | PCL* alone | 278 | 280-358 | — |
| 2 | PCL* + Mont-Na⁺ | 288 | 326-408 | 2.6 |
| 3 | PCL* + Mont- | 278 | 347-408 | 3.5 |
| | C18NH3⁺ | | | |
| 4 | PCL* + Mont- | 286 | 402 | 3.3 |
| | 2CNC8C18 | | | |
| 5 | PCL* + Mont- | 281 | 316-414 | 3.0 |
| | 2CNC8C18 + | | | |
| | starch | | | |
| 6 | PCL* + Mont- | 232 | 241-319-415 | 22.4 |
| | C18NH3⁺+ | | | |
| | ATH | | | |

*polycaprolactone (PCL) with molecular mass Mₙ = 47500 (M_{w}/Mₙ = 1.42) used in all mixtures.
**temperatures at maximum/maxima on derivative of TGA curve.

The different materials obtained were also flame tested (qualitative observation test). It could be seen that the ternary mixtures based on PCL, nanofillers and microfillers (mixtures in entries 5 and 6 in Table 5) burned and were consumed very slowly by producing ash (without the production of a flaming drop). Their binary homologues of PCL+microfillers (mixture shown as entry 2 in the table) burned and produced inflamed drops without the production of ash. The behaviour of said mixtures was identical to that of polycaprolactone alone. On the other hand, their binary homologues PCL+nanofillers (mixtures 3 and 4 in Table 5) burned and were consumed, producing ash (without the production of flaming drops), a good indication of the intercalation of polycaprolactone into the filler (production of a nanocomposite). However, it should be noted that these latter burned faster than the corresponding ternary PCL+nanofiller+microfiller mixtures (mixtures shown in entries 5 and 8 in Table 5).

Limiting Oxygen Index measurements (LOI) were carried out to quantify the flame behaviour of the composites obtained. It should be noted that this measurement did not cause any problems for PCL alone, and was characterized by an oxygen index of 21.6%. In contrast, the LOI test could not be carried out on nanocomposite samples (entries 3 and 4 in Table 5), as the time required for ignition of said samples was substantially greater than the time required under standardized LOI test conditions. In other words, we can state that the presence of said fillers (even in a quantity of less than 5% by weight) prevents not only the formation of drops during combustion but also considerably retards ignition of the PCL matrix. This means that the expected barrier effect plays a very important role in the ignition of composites.

1. A method for preparing an aliphatic polyester nanocomposite comprising mixing a nanofiller into at least one monomer that is capable of forming an aliphatic polyester and carrying out intercalative polymerization of the mixture obtained in the presence of a supercritical fluid.

2. A preparation method according to claim 1, characterized in that the monomer is a lactone.

3. A preparation method according to one of the preceding claims, characterized in that the monomer is ε-caprolactone.

4. A preparation method according to claim 1, characterized in that the monomer is a lactide.

5. A preparation method according to any one of the preceding claims, characterized in that the nanofiller is a clay.

6. A preparation method according to claim 5, characterized in that the nanofiller is organomodified with quaternary ammonium N⁺R₁R₂R₃R₄ type ions in which R¹, R², R³ and R⁴, which may be identical or different, represent hydrogen, a C1-C25 alkyl group, a phenyl group or a functionalized alkyl group.

7. A preparation method according to claim 6, characterized in that the nanofiller is organomodified with methyl hydrogenated tallow bis-2-hydroxyethyl ammonium ions.

8. A preparation method according to any one of the preceding claims, characterized in that the supercritical fluid is mainly composed of carbon dioxide.

9. A preparation method according to any one of the preceding claims, also comprising adding a surfactant to the mixture.

10. A preparation method according to any one of the preceding claims, also comprising adding a particulate microfiller to the mixture.

11. A preparation method according to claim 10, characterized in that the particulate microfiller is a thermomechanical strengthener.

12. A method for preparing a nanocomposite according to any one of the preceding claims, characterized in that the nanocomposite is subsequently used as a master batch.

13. A method for mixing a nanocomposite aliphatic polyester obtained in accordance with claim 12 and an unfilled polymer miscible with the aliphatic polyester component of the nanocomposite, comprising mixing the unfilled polymer in the molten state with the polyester nanocomposite.

14. A mixing method according to claim 13, also comprising adding a particulate microfiller when mixing the unfilled polymer in the molten state with the polyester nanocomposite.

15. A mixing method according to claim 14, characterized in that the particulate microfiller is a thermomechanical strengthener.
